(19) United States
(12) Patent Application Publication
(10) Pub. No.: US 2020/0097650 A1
(43) Pub. Date: Mar. 26, 2020

(54) Enterprise Non-Encryption Enforcement And Detection of Ransomware

(71) Applicant: EMC IP Holding Company LLC, Hopkinton, MA (US)

(72) Inventors: Oron Golan, Meitar (IL); Kfir Wolfson, Beer Sheva (IL); Amos Zamir, Beer-Sheva (IL); Udi Shemer, Kfar Saba (IL)

(73) Assignee: EMC IP Holding Company LLC, Hopkinton, MA (US)

(21) Appl. No.: 16/142,737

(22) Filed: Sep. 26, 2018

(51) Int. Cl. G06F 21/55; G06F 21/56; G06F 9/455

(52) U.S. Cl. CPC G06F 21/554; G06F 2221/034; G06F 9/455; G06F 21/56

(57) ABSTRACT

An enterprise storage system and method detects the probability of encryption of data by comparing the level of randomness in the data to a set of increasing thresholds to determine the severity of encryption. Encryption exceeding a high predetermined threshold is determined to be due to ransomware. Upon determining the level of encryption, an appropriate action is taken based upon one or both of the policy of the enterprise or local governmental regulations as to encryption or non-encryption of data.

### BACKGROUND

This invention relates generally to cryptosecurity management of global enterprise data storage to protect the data from malicious ransomware, and more particularly to the enforcement of data protection policies for compliance with policies, standards and local regulations.

There are many standards and governmental regulations applicable to the protection of data with which individuals, enterprises and other organizations must comply. These standards and regulations are concerned with the protection of private data at rest, during transactions, and while it traverses networks. Moreover, the standards and regulations applicable to data protection must be complied with globally, and they vary by geographical location. For example, the European Union General Data Protection Regulation (GDPR) which came into effect on May 25, 2018 requires that controllers and processors of private personal data of individuals which reside in the EU and that enable the individual to be identified secure and protect the personal data from disclosure. This requires, at least, that access to the data be closely controlled, and may require that the data be encrypted. The GDPR applies to individuals, private and public organizations, and public sector entities operating in the EU. Other countries such as China and Russia, on the other hand, prohibit the encryption of data. Such regulations which vary by locale demonstrate the need for organizations to have centralized policy enforcement to ensure compliance in all areas where the organizations operate. Organizations operating globally are finding it difficult to comply with the myriad of applicable local regulations, and are in need of tools and methods to facilitate this compliance task.

In addition to complying with applicable data protection regulations of the operating locale, organizations also have their own internal data protection standards and requirements. For instance, they need to protect their own frequently diverse types of systems from malware such as ransomware. Ransomware is a type of malicious software (“malware”) which takes control of a computer system usually by encrypting the computer system's data and blocking access to the data unless a ransom is paid. Recovering the encrypted files without the decryption key is typically an intractable problem, and the difficulties in tracing the digital currencies typically used for paying the ransom makes finding the perpetrators unlikely. Even if the ransom is paid, there is still no assurance that the encrypted data can be recovered. For enterprises and organizations which become victims of ransomware attacks, the consequences can be devastating. Ransomware that enters a shared location within a network can effectively paralyze the organization's operations. Advanced ransomware, such as Locky, not only encrypts the local files of the machine it infects, it also encrypts files on network shares (even unmapped ones) and deletes shadow volume copies so they cannot be used for restoration. Thus, a centralized approach which does not depend upon local protection of an endpoint machine is necessary for protection for network data stores. Enterprises that have global operations are especially susceptible to attack. Therefore, detecting and preventing ransomware attacks can save enterprises from huge losses due to interrupted operations, data loss, and other consequences.

Standard antivirus approaches to malware detection perform routine file scans and compare detected file signatures with signatures in a database of known malware. This approach may be effective for blocking known malware, but it does not identify or protect against either new malware having a different signature or old malware that has been repackaged with a new signature. Not surprisingly, hackers have caught on to this critical weakness and are engineering ransomware and other malware to avoid antivirus programs. For example, hackers may use polymorphic malware that is engineered to mutate by changing its own file name or signature so that it will not be recognized by antivirus programs. Other ways of avoiding detection include employing tools such as cryptors or obfuscators that change the appearance of a file, or by using fileless delivery of ransomware as, for example, through registry keys. Such approaches may allow malware attacks to evade antivirus file scans and go undetected.

Preventing and defending against such attacks is vital for organizations of all sizes, not just major enterprises. Thus, businesses and other organizations have a need for real-time protection, and because they may use different types of platforms across their networks, platform independent solutions which address these issues.

There is a need for systems and methods that address the foregoing and other problems associated with data storage and protection by affording a centralized approach to enforcing a no-encryption policy that is applicable to different operating locations while also affording a real time approach for quickly detecting and preventing ransomware attacks at the storage level. The invention is directed to systems and methods that address the foregoing and other known issues effecting enterprise systems.

### BRIEF DESCRIPTION OF THE DRAWINGS

FIG. 1 is diagrammatic view of an SDS virtualized system in which the invention may be used;

FIG. 2 is a functional block diagram illustrating an overview of a data storage system 40 in accordance with an embodiment of the invention; and

FIG. 3 is a diagrammatic view that illustrates an embodiment of a workflow of a detection process in accordance with the invention that may be performed on I/O data of a server.

### DESCRIPTION OF PREFERRED EMBODIMENTS

The invention is especially well adapted for use in cryptosecurity management and for enforcement of data encryptions policies applicable to different operating locations, and in detecting ransomware in global enterprises and other such organizations, and will be described in that context. It will be appreciated, however, from the description that follows that this is illustrative of only one utility of the invention and that the invention is applicable as well to other environments and other purposes.

As will be described, the invention affords a convenient way of enforcing a no-encryption policy at the storage level by using existing algorithms for detecting encryption, while at the same time providing crypto security defense for detecting ransomware encryption and for providing an alert in case an application layer detection process fails to detect the ransomware.

Enterprise systems may employ a disparate set of different types of hardware. In order to afford platform independence, the invention preferably operates on a software defined storage (SDS) approach comprising computer data storage software for policy-based provisioning and management of data storage independent of the underlying hardware. Software defined storage is based upon a form of storage virtualization to separate the storage hardware from the storage management software, and, as such, is well suited to enterprise systems that employ different types of hardware. Software defined storage advantageously affords a centralized approach to detecting ransomware that operates across different hardware platforms, and also affords centralized policy management of data features.

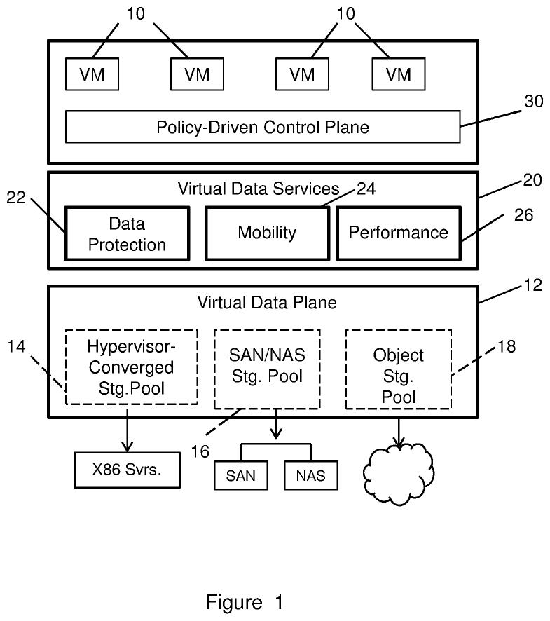

FIG. 1 illustrates diagrammatically an SDS virtualized system such as provided by VMware, Inc., a subsidiary of the assignee of the present invention. As shown in FIG. 1, the SDS system may have three levels (planes) between the virtual machines (VMs) 10 and the storage hardware. These may be a virtual data plane 12 which manages the hardware in storage pools, such as a hypervisor converged storage pool 14 of x86 servers, a SAN/NAS storage pool 16 comprising a storage area network (SAN) and network attached storage (NAS), and an object storage pool 18, such as a cloud. A second plane 20 may be a virtual data services layer which may include data protection 22, mobility 24 and performance 26 services and which may be responsible for snaps, clones, remote replication, data deduplication, data caching, data tiering, data encryption, data archiving, and compliance, for example, for the virtual data plane 12. The third plane 30 may be a policy driven control plane which is responsible for enforcing the policies associated with each of the plurality of VMs 10.

Importantly, the policies associated with each VM are only on the management side of the storage and do not define the properties of the data itself. This allows the properties of the data being stored to be readily determined and controlled to comply with policy and local regulations. It also allows for the application of encryption detection and prevention at the storage level. Data being stored can be recognized in real time as being encrypted when it should not be. If so, data writing may be stopped and the data analyzed to determine the probability that the encryption is due to ransomware, and to determine the severity of the ransomware infection, as will be described.

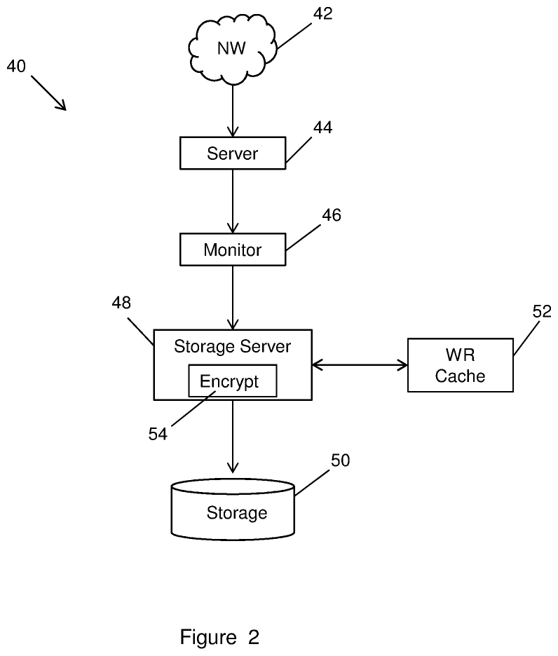

FIG. 2 is a functional block diagram illustrating an overview of a data storage system 40 in accordance with an embodiment of the invention. The system 40 may be located at a data center and connect via a network 42 with a plurality of data sources (not shown). The network 42 may be, for example, a global network having a plurality of different data centers distributed geographically. The system may comprise a server 44 located at the data center that communicates via the network with a plurality of the different data sources to receive data for storage as well as to respond to requests for data. The server may comprise a computer processor and non-transitory memory (not shown) for storing executable instructions for controlling the processor.

A monitor 46, which may comprise a virtual machine process, may receive I/O data of server 44 and analyze the data to determine whether the data is encrypted, and, if so, its level of encryption, as described below. Data from monitor 46 may be forwarded to a storage server 48 (which also comprises a processor and memory storing executable instructions) for handling storage of the data in data stores 50, such as disks. Before storing the data, storage server 48 may first write the data to a write (WR) cache 52 for temporary storage. The monitor 46 may communicate to the storage server 48 the results of its analysis of the data forwarded to the storage server 48. If unintended encryption of the data is detected, the storage server may take appropriate action, as will be described, such as preventing data in the write cache 52 from being written to storage 50.

The storage server may also include an encryption module 54 for encrypting the data prior to storage, if necessary, to comply with the policies of the organization or the regulations of the jurisdiction where the storage system is geographically located. In a situation where the policy of the organization is to encrypt data for transfer over a network, but to store the data unencrypted, the encryption module 54 may also operate to decrypt data either prior to it being stored or upon being read from storage, if necessary, to comply with a policy or the applicable regulations of the geographical location of the data center.

In an embodiment, the system of FIG. 2 may also operate off-line to analyze data in a repository, such as storage 50, for encryption, and issue an alert if unintentional or unwanted encryption is detected.

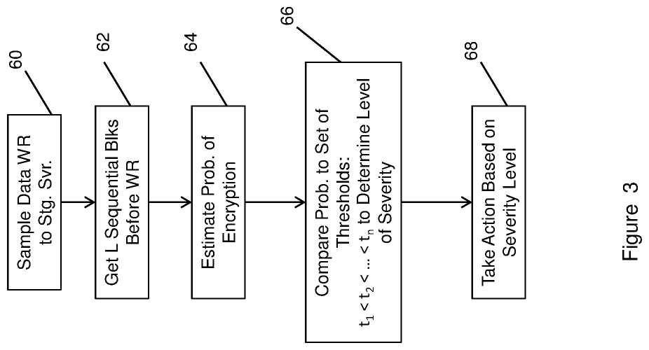

FIG. 3 is a diagrammatic view that illustrates an embodiment of a workflow of a detection process in accordance with the invention that may be performed by monitor 46 on I/O data of server 44. The process of FIG. 3 preferably runs inside of the storage virtualization layer 12 so that it has access to the I/O streams of the virtual machines 10. As shown, at 60 the monitor may intercept or otherwise sample the data writes from server 44 to the storage server 48, and analyze at 62 a predetermined number, L, of sequential blocks of the data before it is written to storage. The predetermined number, L, may be selected based upon different factors, as will be described, but is preferably selected to be large enough to avoid false positives. In an embodiment, a data size such as 100 KB may be selected, but L is preferably changeable, as will be described.

At 64, an estimate of the probability of encryption of the L blocks of data (p=encryption_prob) may be determined. In an embodiment, a combined probability of encryption may be determined by combining the separate probability determinations made for pluralities of different L blocks of data. Encryption may be detected in different ways, but a preferred approach to detect encryption is to first determine the Shannon entropy which is a measure of randomization in the data (see, e.g., U.S. Pat. No. 8,799,671 to Conte, et al.). The entropy so determined may be combined with other statistics, such as Chi square, to improve the determination of encryption by differentiating encryption from compression, as described, e.g., in Craig, “Differentiate Encryption From Compression Using Math”, Embedded Systems, Reverse Engineering Tutorials, /DEV/TTYSO, Jun. 12, 2013 (available at http://www.devttys0.com/2013/06/differentiate-encryption-from-compression-using-math/). Encrypted data typically has little or no variation in entropy. Chi square is normally used to determine a deviation in data from expected results, and this statistic may be used to compare the actual distribution of values in data to the expected distribution of values to estimate randomness.

At 66, a set of probability thresholds t₁<t₂< . . . <tₙ, which relate to different levels (i) of severity may be defined, and the probability of encryption, p, determined as described herein may be compared with each threshold, tᵢ, to determine whether the probability exceeds each threshold. If p>tᵢ, the process may trigger an action at 68 that is bound to the corresponding severity level, i, according to the policy.

The values of L, t and the encryption_prob function, p, implementation may depend on different policies and the particular situation. The values may differ according to the application being monitored, the source of the data, e.g., the department to which the particular virtual machine from which the data is received belongs, past experience, etc. The different levels of severity may, for example, trigger different alerts and different actions. At a high level of severity, the process may also block the I/O operation. The blocking could be performed, for example, only after several L block sequences are found to be encrypted to afford a higher level of confidence in the determination of encryption.

Upon determining that data is encrypted, one action that may be taken is to determine whether the encryption is intentional. It may be the policy of the enterprise to encrypt data that is transmitted over a network, as between data centers, for instance. In addition, a determination may also be made as to whether the encryption or non-encryption in is compliance with local regulations. As previously described, local regulations may require that certain types of data, such as the personal data of residents of the country or region be encrypted to protect the personal information from discovery, as is the case with the GDPR, while the local regulations of other countries may prohibit encryption of data, as previously described. If the encryption is not intentional or is not pursuant to a required policy or regulation, the data may be analyzed further using other known techniques to determine whether the encryption is due to ransomware. If so, other actions may be taken as appropriate to protect the data and to contain the spread of the ransomware. Petya, a know form of ransomware, for example, operates by modifying the master boot record (MBR) to hijack the normal loading process of an infected computer during a next system boot. The modified MBR is used to encrypt the hard disk while simulating a CHKDSK screen. The use of a write cache of a storage server to hold data temporarily before it is written to disk is advantageous in affording time to react when unintentional encryption is detected. By affording early detection of ransomware encryption activity, the invention enables encryption to be immediately blocked to minimize the damage.

As noted, the monitor process does not necessarily have to run on a stream of I/O data. It may also operate on data at rest in the storage virtualization layer, either periodically or on demand. Moreover, it may be implemented in other than the storage virtualization layer. It could be implemented on a physical storage array, or on a file system server, or on a protection approach, e.g., backup or replication software such as RecoverPoint of the Assignee of this invention.

As will be appreciated from the foregoing, the invention affords agentless and centralized real time protection from ransomware, and leverages the centralized ability of the SDS system to enforce policies of encryption and non-encryption, and enables a global organization to align its activities with the regulations of specific countries automatically and in a manageable manner. As such, it opens new opportunities for new policies for real time detection of and response to malicious activity with appropriate action at the management level and in I/O operations.

While the foregoing has been with respect to particular embodiments, it will be appreciated that changes to these embodiments may be made without departing from the principles of the invention, which are defined in the appended claims.

1. A method of detecting encryption of data in an enterprise data storage system, comprising:
providing a virtualization system for managing the storage of data received by said virtualization system from a data source;
analyzing said received data to determine a probability of encryption of said received data prior to writing said received data to data storage;
comparing said determined probability with each one of a set of threshold levels having increasing values to determine a severity level of said encryption; and
taking an action determined by a policy of said enterprise based upon said severity level of said encryption.

2. The method of claim 1, wherein said analyzing comprises analyzing a predetermined number, L, blocks of sequential data in real time to determine a measure of randomness in said data, and detecting encryption based upon said measure of randomness.

3. The method of claim 2, wherein said predetermined number of blocks is selected based upon the type of data received and the source of said received data.

4. The method of claim 2, wherein said analyzing said received data comprises determining a measure of entropy in said received data and applying another statistic to determine a deviation in said randomness in said data from an expected result.

5. The method of claim 4, wherein said applying another statistic comprises using Chi square to differentiate encryption of said received data from compression of said received data.

6. The method of claim 1, wherein, upon determining that said severity level of encryption exceeds a predetermined threshold level, determining that said encryption is due to ransomware, and taking said action comprises issuing an alert and blocking writing of said data to said storage.

7. The method of claim 1, wherein said taking said action comprises ensuring that said encryption of said data complies with governmental regulations applicable to a location of said enterprise data storage.

8. The method of claim 1, wherein said virtualization system comprises centralized platform independent software defined storage, and wherein said method of detecting encryption is performed by a virtual machine of said virtualization system.

9. A non-transitory storage medium embodying executable instructions for controlling a processor to perform a method of detecting encryption of data in an enterprise data storage system, the method comprising:
providing a virtualization system for managing the storage of data received by said virtualization system from a data source;
analyzing said received data to determine a probability of encryption of said received data prior to writing said received data to data storage;
comparing said determined probability with each one of a set of threshold levels having increasing values to determine a severity level of said encryption; and
taking an action determined by a policy of said enterprise based upon said severity level of said encryption.

10. The non-transitory storage medium of claim 9, wherein said analyzing comprises analyzing a predetermined number, L, blocks of sequential data in real time to determine a measure of randomness in said data, and detecting encryption based upon said measure of randomness.

11. The non-transitory storage medium of claim 10, wherein said analyzing said received data comprises determining a measure of entropy in said received data in combination with applying another statistic to determine a deviation in said randomness in said data from an expected result.

12. The non-transitory storage medium of claim 9, wherein, upon determining that said severity level of encryption exceeds a predetermined threshold level, determining that said encryption is due to ransomware, and taking said action comprises issuing an alert and blocking writing of said data to said storage.

13. The non-transitory storage medium of claim 9, wherein, upon determining that said severity level of encryption exceeds a predetermined threshold level, determining that said encryption is due to ransomware, and taking said action comprises issuing an alert and blocking writing of said data to said storage.

14. The non-transitory storage medium of claim 9, wherein said taking said action comprises ensuring that said encryption of said data complies with governmental regulations applicable to a location of said enterprise data storage.

15. The non-transitory storage medium of claim 9, wherein said virtualization system comprises platform independent software defined storage, and wherein said method of detecting encryption is performed at a centralized location of said enterprise.

16. An enterprise data storage system, comprising:
a server receiving data for storage from a network, the server comprising a virtualization system for managing the storage of said received data;
a virtual machine monitor configured to analyze in real time blocks of said received data to determine a probability of encryption of said received data;
a virtual machine processor configured to compare said probability of encryption to each one of a set of thresholds having increasing values to determine a severity level of said encryption; and
a storage server configured to take an action determined by a policy of said enterprise, said policy being determined by one or both of said severity level of said encryption or local regulations regarding encryption of data that are applicable to said location of said storage system.

17. The enterprise data storage system of claim 16, wherein said virtualization system comprises a central platform independent software defined storage application executing on a virtual machine of said system.

18. The enterprise storage system of claim 16, wherein said monitor is configured to determine a measure of randomness in a sequence of said received data, and to determine a deviation in said measure of randomness from an expected result.

19. The enterprise storage system 16, wherein said storage server is configured to provide an alert and to block storage of said received data upon determining that said encryption is due to ransomware.
